(19) United States
(12) Patent Application Publication
(10) Pub. No.: US 2008/0305809 A1
(43) Pub. Date: Dec. 11, 2008

(54) Control of Communication Signal Transmission Based on Transceiver Proximity Estimation

(75) Inventor: Anthony D. Sayers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIKKE PHILIPS ELECTRONICS N.V., EINDHOVEN (NL)

(21) Appl. No.: 12/097,523

(22) PCT Filed: Dec. 19, 2006
(86) PCT No.: PCT/IB06/54950

§ 371 Date: Jun. 14, 2008

(30) Foreign Application Priority Data
Dec. 22, 2005 (EP) 05112846.0

(51) Int. Cl. H04Q 7/20

(52) U.S. Cl. 455/456.1

(57) ABSTRACT

Radio transceivers 5 in a communication system periodically broadcast signal pulses 6 to enable a radio transceiver 5 to determine their proximity. Each radio transceiver 5 has a clock 16 for maintaining a time synchronised by a synchronisation means 17 via the Global Positioning System (GPS). Each radio transceiver 5 transmits a signal pulse 6 at the same point in the synchronised time. A signal detector 19 detects the start of a signal pulse 6 received from the closest radio transceiver 5 and a proximity estimator 20 estimates the proximity of the closest radio transceiver 5 by determining the difference between the point in the synchronised time at which the signal pulses 6 are broadcast and the point in the synchronised time at which the start of a signal pulse 6 received from another radio transceiver 5 is detected. A controller 21 compares the estimated proximity to a threshold and, if the proximity estimate is less than a given threshold, it prevents a transmission means 7 of the radio transceiver 5 from transmitting a communication signal.

### FIELD OF THE INVENTION

This invention relates to a radio transceiver for communicating with other radio transceivers, to a method of controlling such communication, to a communication system comprising radio transceivers, and to a method of communication. More specifically, the invention relates to controlling transmission of communication signals by the radio transceiver based on an estimation of the proximity of the other transceivers. The invention is particularly, but not exclusively, applicable to cognitive radio communication systems.

### BACKGROUND OF THE INVENTION

All radio communication systems have a limited bandwidth within which to transmit communication signals. This inevitably limits communication capacity. Different radio communication systems share this limited capacity in different ways, e.g. by requiring different radio transceivers to transmit communication signals in different parts of the available bandwidth or by causing different radio transceivers to transmit communication signals at different times. However, when radio communication systems share communication capacity using these methods in a predetermined manner, they often fail to use the total available communication capacity. For example, parts of the bandwidth or portions of time may be allocated to a radio transceiver when it does not require to transmit a communication signal. These parts of the bandwidth or portions of time may therefore be wasted.

This problem has lead to the development of so-called “cognitive” radio communication systems that allow radio transceivers to adapt their transmissions according to an assessment of the likely available communication capacity in a communication system. For example, communications systems using the Institute of Electrical and Electronics Engineers (IEEE) 802.11a/b/g and 802.15 standards allow radio transceivers to use a process known as Carrier Sense Multiple Access (CSMA) to decide whether or not to transmit a communication signal. This involves the radio transceiver monitoring its environment by detecting communication signals being transmitted by other nearby transceivers that might interfere with a communication signal the radio transceiver wishes to transmit or might be interfered with by a communication signal the radio transceiver wishes to transmit. The radio transceiver may transmit a communication signal only when it determines that this interference is sufficiently low. So, the radio transceiver can use spare communication capacity that it determines is available, which can allow better exploitation of the total communication capacity of the communication system. However, the radio transceiver's monitoring of its environment is only based on the presence of communication signals transmitted by nearby transceivers and not on the presence of nearby transceivers attempting to receive communication signals. So, the radio transceiver cannot always determine whether or not transmitting a communication signal will cause interference at a nearby receiving transceiver. This difficulty can be referred to as the “hidden terminal” problem.

In more detail, referring to FIG. 1, in a communication system 1, a first radio transceiver 2 is transmitting a communication signal to a second radio transceiver 2 along a communication path A. A third radio transceiver 2 wishes to transmit a communication signal and monitors its environment to determine whether it is able to do so. The communication path B between the first radio transceiver 2 and the third radio transceiver 2 is blocked by an object 3. This means that the third radio transceiver 2 cannot detect the communication signal being transmitted by the first radio transceiver 2. The third radio transceiver 2 may therefore erroneously conclude that it can transmit a communication signal without interfering with the communication signal being received by the second radio transceiver 2 from the first radio transceiver 2 over the communication path A. However, when it does so, the transmission will cause significant interference at the second radio transceiver 2. The third radio transceiver 2 does not take into account the presence of the second radio transceiver 2, which is receiving, but not transmitting, a communication signal nearby.

Referring to FIG. 2, basically the same problem can occur without the presence of an object blocking the communication path B between the first radio transceiver 2 and the third radio transceiver 2. Here, the first radio transceiver 2 is transmitting a communication signal to the second radio transceiver 2 along a communication path C over a distance close the maximum range of the communication signal. The third radio transceiver 2 is located further away from the first radio transceiver 2 than the second radio transceiver 2, such that the length of the communication path D between the first radio transceiver 2 and the third radio transceiver 2 is greater than the range of the communication signal transmitted by the first radio transceiver 2. So, the third radio transceiver 2 cannot detect the communication signal being transmitted by the first radio transceiver 2 and may therefore erroneously conclude that it can transmit a communication signal without interfering with this communication signal. However, the third radio transceiver 2 is located relatively close to the second radio transceiver 2 and if the third radio transceiver 2 transmits a communication signal, the transmission will cause significant interference at the second radio transceiver 2.

Of course, these are merely examples of when a radio transceiver 2 is unable to detect that it may cause interference by transmitting a communication signal and many other similar scenarios can be envisaged, such as when a communication signal is encoded using specific encoding, particularly spread spectrum encoding, not known to a monitoring radio transceiver. However, the common theme is that a radio transceiver seeking to transmit a communication signal can fail to detect the presence of a nearby transceiver and erroneously transmit a communication signal that causes interference at the undetected transceiver.

The present invention seeks to overcome this problem.

### SUMMARY OF THE INVENTION

According to a first aspect of the present invention, there is provided a radio transceiver for communicating with other radio transceivers in a radio communication system, the radio transceiver comprising:

a proximity estimator for estimating the proximity of one or more of the other radio transceivers;

transmission means for transmitting a communication signal in the radio communication system; and

a controller for controlling the transmission means not to transmit the communication signal when the estimated proximity/ies is/are less than a given threshold.

Also, according to a second aspect of the present invention, there is provided a method of controlling communication of a radio transceiver with other radio transceivers in a radio communication system, the method comprising:

estimating the proximity of one or more of the other radio transceivers; and

controlling a transmission means of the radio transceiver not to transmit a communication signal in the communication system when the estimated proximity/ies is/are less than a given threshold.

Controlling the transmission of the communication signal based on the proximity of other radio transceivers instead of or as well as the presence of other communication signals can avoid the “hidden terminal” problem, as other radio transceivers can be taken into account regardless of whether they are themselves transmitting a communication signal that can be detected by the radio transceiver. So, the invention can significantly improve capacity sharing in cognitive radio communication systems and such like.

The proximity estimation can be carried out in a variety of ways. However, it is preferred that the radio transceiver comprises reception means for receiving signal pulses broadcast by the other radio transceivers and that the proximity estimator bases the proximity estimate(s) on the signal pulse(s) received from the one or more of the other radio transceiver(s). Similarly, it is preferred that the method comprises receiving signal pulses broadcast by the other radio transceivers and that the proximity estimate(s) is/are based on the signal pulse(s) received from the one or more of the other radio transceiver(s).

The signal pulses are usually distinct from and additional to the communication signals transmitted in the communication system. In order for the system to be reliable, it is preferred that all of the radio transceivers broadcast the signal pulses. In particular, it is preferred that the subject radio receiver broadcasts a signal pulse itself. In other words, the transmission means of the radio transceiver may also broadcast a signal pulse to the other radio transceivers.

The proximity estimate(s) are preferably based on a difference between a point in time at which a respective signal pulse is broadcast and a point in time at which the signal pulse is received by the reception means. Conveniently, the signal pulses may all be broadcast at the same point(s) in time. This can minimise the communication capacity of the communication system occupied by the signal pulses. This can also allow the time of broadcast to be known to each of the radio transceivers. So, in particular, the transmission means of the subject radio transceiver may broadcast its signal pulse(s) at the same point in time as the other radio transceivers broadcast their signal pulses. Likewise, the method may comprise broadcasting the signal pulse(s) at the same point in time as the other radio transceivers broadcast their signal pulses.

It should be understood that the invention extends to a communication system incorporating all the radio transceivers. So, according to third aspect of the present invention, there is provided a communication system comprising a plurality of radio transceivers for communicating with one another in the communication system, wherein each of the radio transceivers broadcasts a signal pulse to the other radio transceivers in order to allow the each of the radio transceivers to estimate the proximity of the other radio transceivers, the signal pulses being transmitted at the same point in time. Also, according to a fourth aspect of the present invention, there is provided a method of communication comprising a plurality of radio transceivers communicating with one another in a communication system and each of the radio transceivers broadcasting a signal pulse to the other radio transceivers in order to allow each of the radio transceivers to estimate the proximity of the other radio transceivers, the signal pulses being transmitted at the same point in time.

Usually, the broadcast of the signal pulses is repeated periodically. This allows the proximity estimation to be repeated periodically. Accordingly, up to date proximity estimates should be available whenever there is a need to control the transmission of a communication signal. The signal pulse(s) also usually has/have duration small in relation to the period of repetition. This means that the capacity of the communication system to carry communication signals is not significantly affected by the broadcast of the signal pulses. The period of repetition might be approximately in the order of 1 s, e.g. between around 0.1 s and 10 s. The period of repetition might be approximately in the order of 100 ns, e.g. between around 10 ns and 1 μs.

One problem that might be encountered in such a system is the misidentification of a signal pulse transmitted by the subject radio transmitter being misidentified as a signal pulse originating from a very close other radio transmitter. It may therefore be preferred that the signal pulse(s) include a marker indicating its/their originating radio transmitter. More specifically, the signal pulse(s) broadcast by the transmission means may include(s) a marker signifying that it/they originate(s) from the radio transceiver. Signal pulses including the marker can then be disregarded. In other words, the proximity detector may be adapted to disregard signal pulses received by the reception means that include the marker. Alternatively, the signal pulse(s) vary in frequency over its/their duration or, more specifically, are swept in frequency. This can allow a radio transceiver to eliminate its own transmissions from the signals it receives by cancelling a signal component of the same frequency variation or sweep at substantially zero delay from the signal it receives, e.g. by mixing.

It will be appreciated that in order to transmit the signal pulses at the same time and to perform a reliable proximity estimate, the radio transceivers should ideally use a synchronised time frame. So, it is preferred that the radio transceiver comprises: a clock for maintaining a time; and synchronisation means for synchronising the time maintained by the clock with a time or times maintained by the one or more of the other radio transceivers, wherein the points in time at which the signal pulses are broadcast and the signal pulse(s) is/are received are determined in the synchronised time. Likewise, it is preferred that the method comprises maintaining a time; and synchronising the maintained time with a time or times maintained by the one or more of the other radio transceivers, wherein the points in time at which the signal pulses are broadcast and the signal pulse(s) is/are received are determined in the synchronised time. Conveniently, the synchronisation may use another radio system. For example, the synchronisation may be carried out using a positioning system, such as the known Global Positioning System (GPS), or such like.

The signal pulses need not carry any other information and may simply have a pure sinusoidal waveform at a given frequency, if desired. However, in order to aid communication signal transmission control, information can be incorporated in the signal pulses. For example, the signal pulses may include a first indication when the other radio transceiver broadcasting a/the respective signal pulse is transmitting a communication signal in the communication system and a second indication when the other radio transceiver broadcasting a/the respective signal pulse is receiving a communication signal in the communication system. The controller may then control the transmission means not to transmit its communication signal based on the presence of the first or second indication in the received signal pulse(s). Similarly, the method may then comprise controlling the transmission means not to transmit its communication signal based on the presence of the first or second indication in the received signal pulse(s). In another example, the signal pulses may include an indication of the power at which the other radio transceiver broadcasting a/the respective signal pulse is transmitting or receiving a communication signal in the communication system. The controller may then control the transmission means not to transmit its communication signal based on the power indication(s) in the received signal pulses. Similarly, the method may comprise controlling the transmission means not to transmit its communication signal based on the power indication(s) in the received signal pulses.

Use of the terms “means”, “detector”, “estimator”, “controller” and so on is intended to be general rather than specific. The invention may be implemented using such separate components. However, it may equally be implemented using components that perform more than one function as defined by these terms, such as one or more processors, digital signal processors (DSPs) or central processing units (CPUs). Similarly, the invention could be implemented using a hard-wired circuit or circuits, such as an application-specific integrated circuit (ASIC), or by embedded software. Indeed, it can also be appreciated that the invention can be implemented using computer program code. According to a further aspect of the present invention, there is therefore provided computer software or computer program code adapted to carry out the method described above when processed by a processing means. The computer software or computer program code can be carried by a computer readable medium. The medium may be a physical storage medium such as a Read Only Memory (ROM) chip. Alternatively, it may be a disk such as a Digital Versatile Disk (DVD-ROM) or Compact Disk (CD-ROM). It could also be a signal such as an electronic signal over wires, an optical signal or a radio signal such as to a satellite or the like. The invention also extends to a processor running the software or code, e.g. a computer configured to carry out the method described above.

### BRIEF DESCRIPTION OF THE DRAWINGS

Preferred embodiments of the invention will now be described, by way of example only, with reference to the accompanying drawings, in which:

FIG. 1 is a schematic illustration of a communication scenario in a communication system according to the prior art;

FIG. 2 is a schematic illustration of another communication scenario in a communication system according to the prior art;

FIG. 3 is a schematic illustration of a communication system according to a preferred embodiment of the present invention;

FIG. 4 is a schematic illustration of a radio transceiver of the communication system shown in FIG. 3;

FIG. 5 is a graphical illustration of a signal pulse broadcast by the radio transceiver shown in FIG. 4; and

FIG. 6 is a schematic illustration of a communication scenario similar to that shown in FIG. 1 but in the communication system shown in FIG. 3 rather than in the communication system according to the prior art.

### DETAILED DESCRIPTION

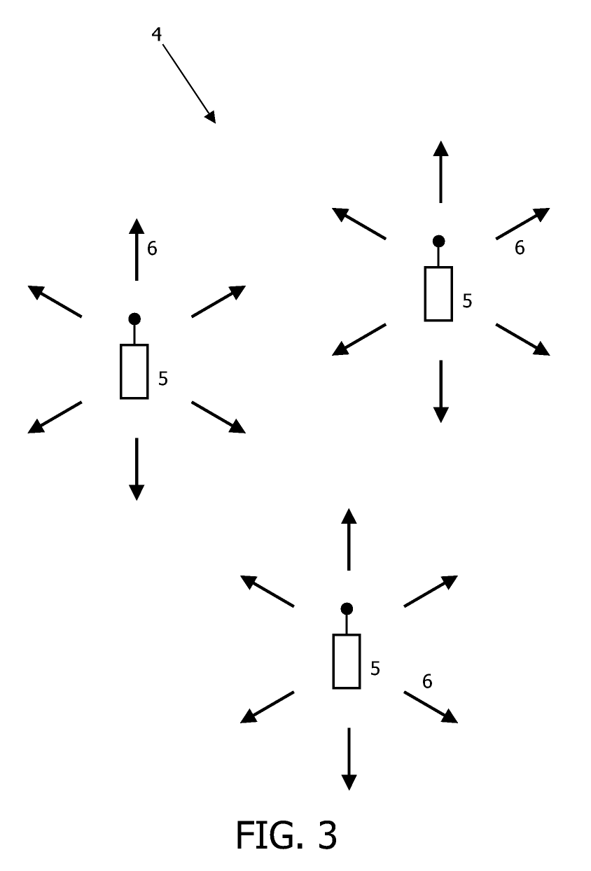

Referring to FIG. 3, a communication system 4 according to a preferred embodiment of the present invention comprises several radio transceivers 5. The radio transceivers 5 communicate in the communication system 4 by transmitting communication signals to one another. In this embodiment, the communication system 4 comprises a mobile telephone network or Wireless Local Area Network (WLAN) and communication signals are transmitted in accordance with the protocols set out in the Institute of Electrical and Electronics Engineers (IEEE) 802.11a/b/g or 802.15 standards. This means, in particular, that the radio transceivers 5 use Carrier Sense Multiple Access (CSMA) to decide whether or not to transmit a communication signal. The radio transceivers 5 also periodically broadcast signal pulses 6 to enable each radio transceiver 5 to determine the proximity of other radio transceivers 5 in the communication system 4 before deciding whether or not to transmit a communication signal.

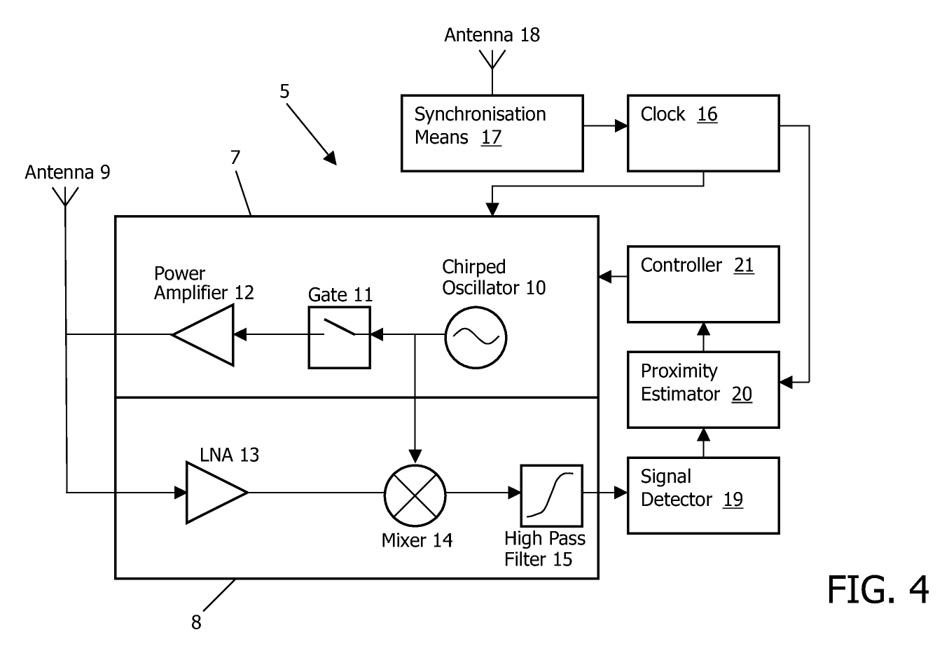

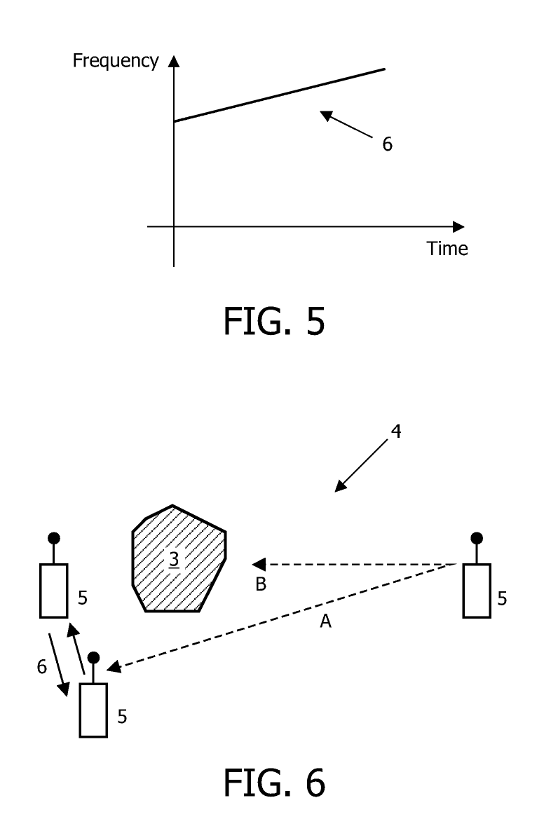

In more detail, referring to FIG. 4, each radio transceiver 5 comprises transmission means 7 and reception means 8 for transmitting and receiving the signal pulses 6 via an antenna 9. In this embodiment, the transmission means 7 and reception means 8 also handle transmission and reception of communication signals via the antenna 9. However, in addition to the conventional components required to transmit communication signals, the transmission means 7 has a chirped oscillator 10 for producing a chirped signal in a given frequency band. In other words, the chirped oscillator outputs a signal that is repeatedly swept in frequency. The transmission means 7 has a gate 11 for selectively outputting the signal from the chirped oscillator 10 to a power amplifier 12. The power amplifier 12 amplifies the selectively output signal and outputs it to the antenna 9 for transmission as the signal pulses 6. So, the signal pulses 6 each take a form roughly as represented graphically in FIG. 5.

Similarly, in addition to the conventional components required to receive communication signals, the reception means 8 has a Low Noise Amplifier (LNA) 13 connected to the antenna 9. Broadcast signal pulses 6 received at the antenna 9 are amplified by the LNA 13 and output to a mixer 14. The mixer 14 mixes the amplified received signal pulses 6 with the signal output by the chirped oscillator 10 and outputs the mixed signal to a high pass filter 15. It will be appreciated that as well as receiving signal pulses 6 broadcast by other radio transceivers 5, the reception means 8 inevitably receives the signal pulses 6 broadcast by the transmission means 7 of its own radio transceiver 5. However, as there is virtually no time delay between the signal pulses 6 received by the reception means 8 from the transmission means 7 and the signal output by the chirped oscillator 10, the frequency of these signal pulses 6 and that signal are substantially the same. So, mixing and suitably filtering the amplified received signal pulses has the effect of removing the signal pulses 6 broadcast by the transmission means 7 of the reception means own radio transceiver 5 from the amplified received signal pulses.

Signal pulses 6 are broadcast by all of the radio transmitters 5 at the same time. In order to achieve this, each radio transmitter 5 has a clock 16 for maintaining a synchronised time and synchronisation means 17 for synchronising the time by synchronisation signals received at another antenna 18. In this embodiment, the synchronisation means 17 is a Global Positioning System (GPS) receiver. This is used by the radio transceiver 5 to determine a geographical position in a conventional manner, which position can be used for other functions as desired. The GPS system includes synchronisation functionality that allows the clock 16 to maintain a synchronised time accurate to around a few nanoseconds. The transmission means 7 broadcasts the signal pulses 6 by controlling the gate 11 to output the signal from the chirped oscillator 10 at points in this synchronised time, maintained by the clock 16, which points are the same in each of the radio transceivers 5. In this embodiment, signal pulses 6 are output every 1 s and each have duration around 100 ns.

The reception means 7 outputs the filtered signal to a signal detector 19. The signal detector 19 detects the start of a signal pulse 6 in the filtered signal and outputs a detection signal to a proximity estimator 20 on detection of the start of a signal pulse 6. It will be appreciated that the start of a signal pulse 6 received from a nearby radio transceiver 5 is likely to be within the duration of the signal pulse 6 broadcast by the transmission means 7 of the signal detector's radio transceiver 5 at the same time. For example, if the nearby radio transceiver 5 is say 10 m away, the start of its signal pulse 6 will be received around 30 ns after the start the signal pulse 6 broadcast by the transmission means 7 of the signal detector's radio transceiver 5, i.e. within the 100 ns duration. However, as the contribution from the signal pulse 6 broadcast by the transmission means 7 of the signal detector's own radio transceiver 5 is removed by the mixer 14 and high pass filter 15, the first signal pulse 6 detected by the signal detector 19 is that broadcast by the radio transceiver 5 closest to the signal detector's own radio transceiver 5.

In this embodiment, a proximity detector 20 determines the difference in the point in the synchronised time maintained by the clock 16 at which the signal pulses 6 were broadcast and the point in the synchronised time at which it receives the detection signal from the signal detector 19 and uses this difference to estimate the proximity of the nearest radio transceiver 5. The proximity estimator 20 outputs the estimated proximity estimate to a controller 21 for controlling the transmission of communication signals by the radio transceiver 5. The controller 21 compares the estimated proximity to a threshold and, if the proximity estimate is less than the threshold, it prevents the transmission means 7 from transmitting a communication signal.

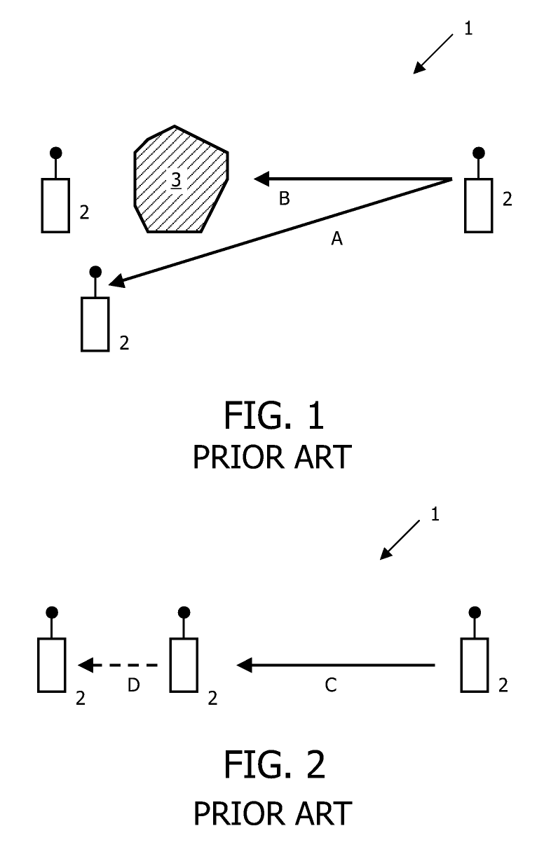

So, referring to FIG. 6, in a communication scenario similar to that described with reference to FIG. 1 for the prior art, in the event that a first radio transceiver 5 according to the invention is transmitting a communication signal to a second radio transceiver 5 according to the invention along a communication path A, but a communication path B between the first radio transceiver 5 and the third radio transceiver 5 according to the invention is blocked by an object 3, the third radio transceiver can detect the proximity of the second radio transceiver 5 from the signal pulse it receives from the second radio transceiver 5. If the third radio transceiver 5 determines that the second radio transceiver 5 is sufficiently close that transmitting a communication signal will interfere with the communication signal being received by the second radio transceiver 5, the third radio transceiver 5 does not transmit a communication signal.

The preferred embodiment of the invention described above is suitable for improving communication in many communication systems. However, communication can be further improved by the signal pulses carry information about the radio transceiver 5 broadcasting them. So, in another embodiment, the controller 21 controls the chirped oscillator 10 to change its signal between a first frequency range and a second frequency range according to whether or not the radio transceiver 5 is currently receiving or transmitting a communication signal. The signal detector 19 and proximity detector 20 can then distinguish between signal pulses 6 received from transmitting radio transceivers 5 and receiving radio transceivers 5. In another embodiment, the controller 21 controls the chirped oscillator 10 to vary the frequency of its signal according to the power at which the radio transceiver 5 is transmitting or receiving a communication signal. The signal detector 19 and proximity detector 20 can then distinguish between signal pulses 6 received from radio transceivers 5 transmitting and receiving at different powers and pass this information to the controller 21.

Of course, the described embodiments of the invention are only examples of how the invention may be implemented. Other modifications, variations and changes to the described embodiments will also occur to those having appropriate skills and knowledge. These modifications, variations and changes may be made without departure from the spirit and scope of the invention defined in the claims and its equivalents.

In the present specification and claims the word “a” or “an” preceding an element does not exclude the presence of a plurality of such elements. Further, the word “comprising” does not exclude the presence of other elements or steps than those listed. The inclusion of reference signs in parentheses in the claims is intended to aid understanding and is not intended to be limiting.

1. A radio transceiver (5) for communicating with other radio transceivers (5) in a radio communication system (4), the radio transceiver (5) comprising:
a proximity estimator (20) for estimating the proximity of one or more of the other radio transceivers (5);
transmission means (7) for transmitting a communication signal in the radio communication system (4); and
a controller (21) for controlling the transmission means (7) not to transmit the communication signal when the estimated proximity/ies is/are less than a given threshold.

2. The radio transceiver (5) of claim 1, comprising reception means (8) for receiving signal pulses (6) broadcast by the other radio transceivers (5) and wherein the proximity estimator (20) bases the proximity estimate on a signal pulse (6) received from the one or more of the other radio transceiver.

3. The radio transceiver (5) of claim 2, wherein the proximity estimator (20) bases the proximity estimate on a difference between a point in time at which a respective signal pulse (6) is broadcast and a point in time at which the signal pulse (6) is received by the reception means (8).

4. The radio transceiver (5) of claim 2, comprising:
a clock (16) for maintaining a time; and
synchronisation means (17) for synchronising the time maintained by the clock (16) with a time maintained by the one or more of the other radio transceivers (5),
wherein the points in time at which the signal pulses (6) are broadcast and the signal pulses are received are determined in the synchronised time.

5. The radio transceiver (5) of claim 4, wherein the synchronisation means (17) synchronises the time using another radio system.

6. The radio transceiver (5) of claim 5, wherein the other radio system is a positioning system.

7. The radio transceiver (5) of claim 2, wherein the signal pulses include a first indication when the other radio transceiver (5) broadcasting a respective signal pulse (6) is transmitting a communication signal in the communication system (4) and a second indication when the other radio transceiver (5) broadcasting a respective signal pulse (6) is receiving a communication signal in the communication system (4); and the controller (21) controls the transmission means (7) not to transmit its communication signal based on the presence of the first or second indication in the received signal pulses.

8. The radio transceiver (5) of claim 2, wherein the signal pulses include an indication of the power at which the other radio transceiver (5) broadcasting a respective signal pulse (6) is transmitting or receiving a communication signal in the communication system; and the controller (21) controls the transmission means (7) not to transmit its communication signal based on the power indication in the received signal pulse.

9. The radio transceiver (5) of claim 2, wherein the transmission means (7) of the radio transceiver (5) also broadcasts a signal pulse (6) to the other radio transceivers (5).

10. The radio transceiver (5) of claim 9, wherein the transmission means (7) broadcasts its signal pulse (6) at the same point in time as the other radio transceivers (5) broadcast their signal pulses.

11. The radio transceiver (5) of claim 2, wherein the broadcast of the signal pulses (6) is repeated periodically.

12. The radio transceiver (5) of claim 9, wherein the signal pulses broadcast by the transmission means (7) include a marker signifying that they originate from the radio transceiver (5) and the proximity detector (20) is adapted to disregard signal pulses (6) received by the reception means (8) that include the marker.

13. The radio transceiver (5) of claim 2, wherein the signal pulses vary in frequency over their duration.

14. The radio transceiver (5) of claim 2, wherein the signal pulses are swept in frequency.

15. (canceled)

16. A communication system (4) comprising a plurality of radio transceivers (5) for communicating with one another in the communication system (4), wherein each of the radio transceivers (5) broadcasts a signal pulse (6) to the other radio transceivers (5) in order to allow the each of the radio transceivers (5) to determine the proximity of the other radio transceivers (5), the signal pulses (6) being transmitted at the same point in time.

17. A method of controlling communication of a radio transceiver (5) with other radio transceivers (5) in a radio communication system (4), the method comprising:
estimating the proximity of one or more of the other radio transceivers (5); and
controlling a transmission means (7) of the radio transceiver (5) not to transmit a communication signal in the radio communication system when the estimated proximity is less than a given threshold.

18. The method of claim 17, comprising receiving signal pulses (6) broadcast by the other radio transceivers (5) and wherein the proximity estimate is based on the signal pulse received from the one or more of the other radio transceivers.

19. The method of claim 18, wherein the proximity estimate is based on a difference between a point in time at which a respective signal pulse (6) is broadcast and a point in time at which the signal pulse (6) is received by a reception means (8) of the radio transceiver (5).

20. The method of claim 18, comprising:
maintaining a time; and
synchronising the maintained time with a time or times maintained by the one or more of the other radio transceivers (5),
wherein the points in time at which the signal pulse is broadcast and the signal pulse is received are determined in the synchronised time.

21. The method of claim 20, wherein the synchronisation comprises synchronising the time using another radio system.

22. The method of claim 21, wherein the other radio system is a positioning system.

23-32. (canceled)
